(19) United States
(12) Patent Application Publication
(10) Pub. No.: US 2019/0036603 A1
(43) Pub. Date: Jan. 31, 2019

(54) Method of Synchronizing Laser-Links Between Aircraft

(71) Applicant: Airborne Wireless Network, Simi Valley, CA (US)

(72) Inventor: Marius Daniel De Mos, Simi Valley, CA (US)

(21) Appl. No.: 15/658,761

(22) Filed: Jul. 25, 2017

(51) Int. Cl. H04B 10/112; H04B 10/29; H04L 7/00

(52) U.S. Cl. CPC H04B 10/112; H04L 7/0075; H04B 10/29

(57) ABSTRACT

The invention relates to a method of synchronizing a laser-link between aircraft, comprising the steps of providing the aircraft with one or more radio antennas/transceivers, and using the one or more radio antennas/transceivers to synchronize the laser-link between the aircraft.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to a method of synchronizing laser-links between (airborne) aircraft, as well as an aircraft for use with such a method and an airborne network of two or more of such (airborne) aircraft.

### BACKGROUND OF THE INVENTION

U.S. Pat. No. 6,285,878 describes the use of existing fleets of commercial airline aircraft to replace low-earth orbit (LEO) communication satellites. U.S. Pat. No. 6,285,878 discloses a low-cost, broadband wireless communication infrastructure by using and modifying existing, small, lightweight low power, low cost microwave relay station equipment onboard commercial airline aircraft.

Each equipped aircraft would have a broadband wireless communication link within line-of-sight coverage ranges to one or more neighboring aircraft or ground stations to form a chain (“dynamic mesh”) of seamless airborne repeaters providing broadband wireless communication gateways along the entire flight path.

Broadband wireless communication services can thus be provided to customers onboard as well as customers overboard.

Lasers can be utilized as part of the above wireless communication infrastructure to facilitate very high data exchange speeds, over vast distances.

However, while lasers can carry large amounts of data hundreds of thousand miles into space, for terrestrial and airborne applications, lasers also face many challenges. These include, adverse weather such as fog, dense clouds, dust, rain, heavy lightning, rising heated air and any other “air mirror” or “mirage” condition.

The primary challenge to an airborne laser network, especially when it is used in a meshed system is “finding the other aircraft”, while trying to join the mesh; this requires dynamic, or “real-time data” on all adjoining aircraft in the mesh.

Even if the links were “locked up” and synchronized, there are limits to traditional methods, such as gyros and GPS/GLONASS managed systems. Unexpected severe turbulence could render these systems inoperative, for brief periods or longer, at any time.

Heavy turbulence could cause the narrowly focused beams to move away from their targets. The unexpected movement of the aircraft could exceed the speed with which the laser's tracking system could compensate; this would interrupt the data-flow, as a minimum for the duration of this condition, and if the affected aircraft had turned away, may never be able to reacquire the targeted aircraft.

In an “air to ground” application, the aircraft “knows” where it is in relation to the “target” and would simply reacquire the target.

However, refocusing a laser between two moving objects, especially those which, due to turbulence, or other weather-related conditions, deviated from their intended and pre-programmed flight plans, would be impossible to achieve without the aid of secondary control-links. Without these, there would be no reliable way to maintain the link.

One option would be a second (air to ground, or satellite-connected) laser, but being able to guarantee global “availability” could prove to be difficult.

Even if the system could resynchronize, any interruptions which are greater than a fraction of a second would make it impossible to support VOIP (“Voice Over IP”).

### SUMMARY OF THE INVENTION

An object of the invention is therefore to provide a method of synchronizing laser-links between aircraft, wherein the laser can be quickly and reliably focused or refocused between the aircraft, in particular airborne aircraft.

Hereto, a method of synchronizing a laser-link between aircraft is provided, comprising the steps of:
providing the aircraft with one or more radio antennas/transceivers,
using the one or more radio antennas/transceivers to synchronize the laser-link between the aircraft.

The abovementioned hybrid solution takes advantage of the laser's high data-throughput ability, and traditional Radio Frequency's (RF) dynamic robustness. Radio is thus advantageously used to overcome the laser's limitations particularly in airborne applications.

Traveling through adverse weather, such as identified in the introduction to this patent application, unless controlled by the RF link, the laser would likely not be able to locate other aircraft in the dynamic mesh.

Even in visibly clear air, air-mirrors/mirages, and severe “clear air turbulence” can be encountered. Either occurrence could render the system inoperative, as both could cause the narrowly focused beams drop out of sync. Radio is then used in parallel with the laser to help the laser acquire or reacquire a laser-link.

An embodiment relates to an aforementioned method, wherein the aircraft are airborne.

An embodiment relates to an aforementioned method, wherein the aircraft are part of a dynamic mesh of airborne aircraft.

An embodiment relates to an aforementioned method, wherein the airborne aircraft are in level flight.

An embodiment relates to an aforementioned method, wherein, when one of the aircraft is on the ground, system data is received from a local earth station. This data contains, but is not limited to, network control data, updated flight crew data, nearby aircraft information and other useful information.

An embodiment relates to an aforementioned method, wherein the system data is received via an omnidirectional radio antenna provided on the aircraft.

An embodiment relates to an aforementioned method, wherein, when one of the aircraft is on the ground, the aircraft's laser is directed to a boarding gate or other local terrestrial line-of-sight laser. The laser would then “lock-on and activate” to allow access to large data-files and quickly download these.

An embodiment relates to an aforementioned method, wherein, when one of the aircraft is taxiing and/or taking-off, the aircraft receives updated data regarding the dynamic mesh it is to become part of. The on-board system then receives its updated “pre-mesh data”, so that it will be able synchronize and become a part of the meshed network as soon as practical; only updated data packets would need to be sent, minimizing data transmission requirements.

An embodiment relates to an aforementioned method, wherein, when one of the aircraft becomes airborne after take-off and circumstances are favourable, a laser-link is established between the aircraft and one or more other aircraft of the dynamic mesh, wherein the one or more radio antennas/transceivers are used to synchronize the laser-link between the aircraft when circumstances are unfavorable. As soon as practical (agency regulations or system dependent), the aircraft would switch from its (short-range) omnidirectional radio antenna to its tracking radio antenna to allow it to enter the mesh. Once absorbed into the mesh, and the weather conditions between aircraft are favorable, the system would align the laser and synchronize it to one or more aircraft in the mesh.

At this point, huge amounts of data (many GB/sec) can be transferred between aircraft and terminated at any of the many earth-stations within the network. Where practical, data would be handed off to the earth-stations via laser, and where weather or other circumstances would make the use of laser not desirable, one or more radio/RF links could be used to terminate the data. Terrestrially, the signal would be routed (or backhauled) via the company's terrestrial fiber optic infrastructure.

Another aspect of the invention concerns an aircraft for use with the aforementioned method, comprising:

one or more lasers for establishing a laser-link with other aircraft,

one or more radio antennas/transceivers to synchronize the laser-link between the aircraft.

An embodiment relates to an aforementioned aircraft, further comprising an omnidirectional radio antenna.

An embodiment relates to an aforementioned aircraft, further comprising a GPS or GLONASS antenna.

An embodiment relates to an aforementioned aircraft, wherein the aircraft comprises a cabin with windows, the windows being configured to block laser light from passing through the windows into the cabin. Because of the bandwidth/spectrum and (generally low) intensity of the laser signal as distributed on a “per window” basis, this blocking or filtering may be in the form of a coating, or a window overlay/replacement on the inner or outer window of the aircraft, depending on retrofit or new manufacture.

In particular when bandwidth is increased (eventually up to Tera-bits/sec), even (preferably to be used) “eye-safe lasers” could pose a potential risk if constantly aimed at an aircraft (the beam widens with distance and will likely cover several of the aircraft's windows). The effects of constant exposure to eye-safe laser are currently unknown and therefore the use of for instance optical filters/coating on the aircraft's windows to block most, if not all, of the laser's light is highly recommended.

Another aspect of the invention relates to an airborne network of two or more aforementioned airborne aircraft, the aircraft being part of a dynamic mesh of airborne aircraft.

An embodiment relates to an aforementioned airborne network, wherein the dynamic mesh comprises 10's, 100's or even 1000's of airborne aircraft.

An embodiment relates to an aforementioned airborne network, wherein the airborne network is in communicative contact with one or more earth stations, ships or satellites. The earth station, ship and/or satellites may comprise radio (RE) transceivers, lasers, tracking or non-tracking transceivers, directional or omnidirectional transceivers.

An embodiment relates to an aforementioned airborne network, wherein the communicative contact is established via laser-link.

An embodiment relates to an aforementioned airborne network, wherein, when circumstances are unfavorable for using the laser-link, a radio link is used to establish contact and/or transfer data.

Another aspect of the invention relates to a computer program comprising instructions which, when the program is executed by a computer, cause the computer to carry out the aforementioned method.

Yet another aspect of the invention relates to a computer-readable medium comprising the aforementioned computer program.

### BRIEF DESCRIPTION OF THE DRAWINGS

The present invention will be explained hereafter with reference to exemplary embodiments of a method, aircraft and/or an airborne network according to the invention and with reference to the drawings. Therein:

FIG. 1 shows a schematic depicting the key components required for a “hybrid” airborne (wireless) network according to an exemplary embodiment of the invention;

FIGS. 2A-2C respectively show two aircraft with the laser-link in a locked state, an unlocked state, and an unlocked state with the radio antennas/transceivers being used to synchronize or refocus the laser-link; and

FIG. 3 shows a narrow-band RF signal being used to send aircraft location data to allow the laser to set up a link.

### DETAILED DESCRIPTION OF THE PREFERRED EMBODIMENT

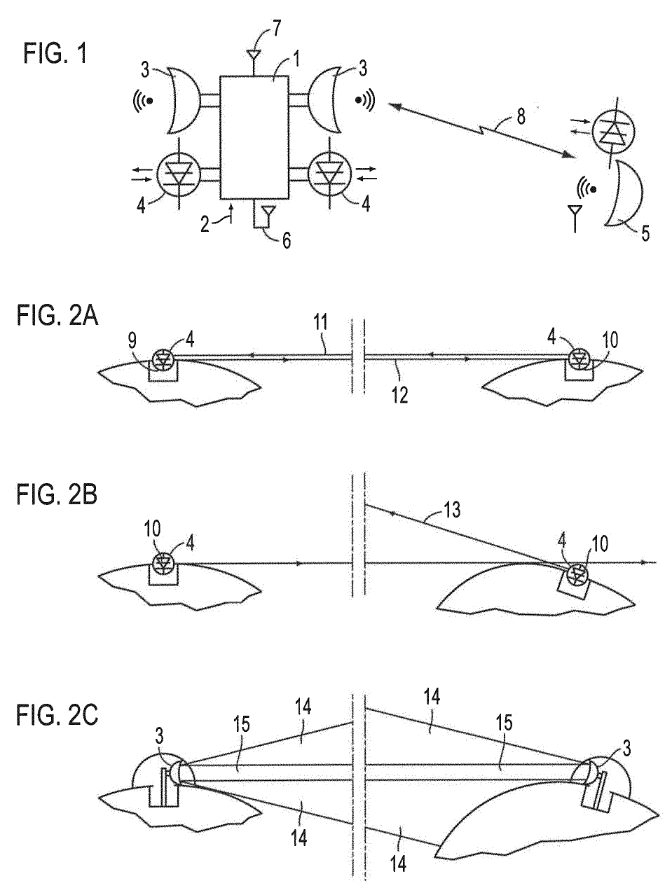

FIGS. 1-3 will be discussed in conjunction. FIG. 1 shows a schematic depicting the key components required for a “hybrid” airborne (wireless) network according to an exemplary embodiment of the invention.

On the Ground

Whilst an aircraft 1 is on the ground, the aircraft 1 would receive system data 8 from a local earth station, satellite or ship 5 via its on-board omnidirectional antenna 6. This control data 8 contains, but is not limited to, network control data, updated flight-crew data, nearby aircraft information and other useful information. The aircraft 1 is preferably provided with a GPS/GLONASS antenna 7 to aid with navigation/positioning.

Although the initial data-link would be via RF, where practical, the aircraft's laser 4 may be directed to the boarding gate or available local terrestrial line-of-sight-laser; it would then “lock-on and activate” to allow access to large data-files and quickly download these.

Transition—Taxi and Take-Off

During taxi and take-off (unless prohibited by local governing agencies), the on-board system of the aircraft 1 receives its updated “pre-mesh data”, so that it will be able synchronize and become a part of the meshed network as soon as practical; only updated data packets would need to be sent, minimizing data transmission requirements.

Airborne

As soon as practical (agency regulations or system dependent), the aircraft 1 would switch from its (short-range) omnidirectional antenna 6 to its tracking antenna 3 to allow it to enter the mesh. Once absorbed into the mesh, and the weather conditions between aircraft 1 are favorable, the system would align the laser 4 and synchronize it to one or more aircraft 1 in the mesh.

At this point, huge amounts of data (many GB/sec) can be transferred between aircraft 1 and terminated at any of the many earth stations 5 within the network. Where practical, data 8 would be handed off to the earth stations via laser 3, and where weather or other circumstances would make the use of laser 4 not desirable, one or more RF links 3 could be used to terminate the data 8. Terrestrially, the signal would be routed (or backhauled) via the company's terrestrial fiber optic infrastructure.

Traveling through adverse weather, unless controlled by the RF link, the laser 4 would likely not be able to locate other aircraft 1 in the dynamic mesh.

Even in visibly clear air, air-mirrors/mirages, and severe “clear air turbulence” can be encountered. Either occurrence could render the system inoperative, as both could cause the narrowly focused beams drop out of sync.

The RF signal has a much greater beam-width and will be able to remain synchronized. Even if the tracking antennas 3 were to fail (get out of sync) the system's omnidirectional (non-tracking) antenna 6 could, in most cases, allow the system to reacquire the mesh's data very quickly and restore the system to its full capacity as quickly as feasible.

As shown in FIG. 2A, during level flight in smooth air, the lasers 4 on aircraft 9 (aircraft A) and aircraft 10 (aircraft B) are locked and the link 11 is synchronized, i.e. two locked laser beams 12 are shown forming a duplex laser link 11. Both aircraft 9 and 10 are shown in level flight.

As shown in FIG. 2B, because laser has an extremely narrow beam-width, during severe turbulence encountered by aircraft 10 the laser 4 could lose lock and may not be able to re-establish a connection; the same is true for the weather conditions previously mentioned. The laser that has lost its lock is indicated by reference numeral 13.

According to the inventive insight underlying the invention, radio has a wider beam-width and it is less likely to lose its “lock” (synchronization).

As shown in FIG. 2C, radio would be used in parallel with the laser 4 to help it acquire or reacquire a laser-link and secondly, as a “virtually uninterrupted link” for VOIP (“Voice Over IP”) data, which cannot be “stored and forwarded”, as is common with large data packets. FIGS. 2A-2C depict these conditions; note, both systems 3, 4 would be installed, but are shown individually for clarity.

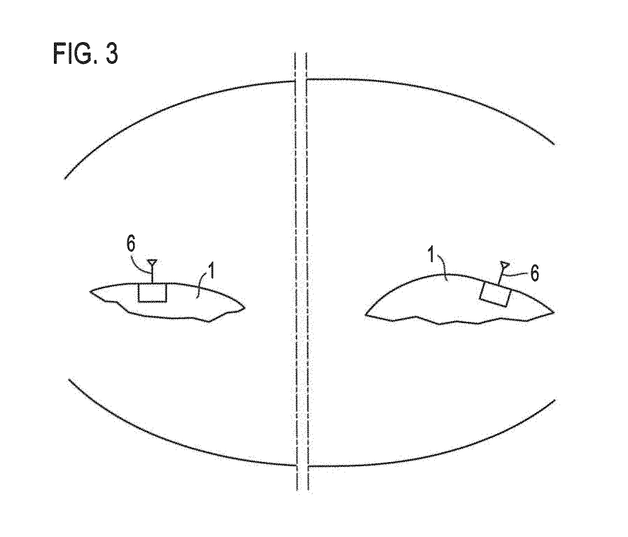

As shown in FIG. 3, when turbulence is extreme, the system uses a narrow-band (any frequency) system with one or more omnidirectional antennas 6 per aircraft 1, to send its navigational data and allow the aircraft 1 to re-establish the laser-link 11. Part of the radio beam emitted by the omnidirectional antennas 6 will then comprise a functional beam portion 15 as well as ineffective beam portions 14.

All aircraft in the airborne network would be fitted with laser-links 11 and would feature either tracking antennas 3, omnidirectional antennas 6 or all the above. Please note that some equipment is omitted in FIGS. 1-3 to improve clarity.

Terrestrial, satellite and/or shipboard repeaters may be used to overcome range limitations.

Although only a few example embodiments have been described in detail above, those skilled in the art will readily appreciate that many modifications are possible in the example embodiments. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

### LIST OF REFERENCE NUMERALS

1. (Commercial) aircraft
2. Right data from the from the aircraft's flight data computer
3. Tracking radio frequency (FR) antenna/transceiver
4. Airborne laser transceiver
5. Earth station, satellite or ship
6. Airborne fixed omnidirectional antenna (i.e. non-tracking)
7. GPS or GLONASS antenna
8. Control data
9. Aircraft A
10. Aircraft B
11. Duplex laser-link
12. Locked laser
13. Unlocked laser
14. Ineffective portion of beam
15. Functional portion of beam

1. A method of synchronizing a laser-link between two or more moving aircraft provided with one or more lasers, comprising:
providing the two or moving aircraft with one or more radio antennas or transceivers,
using the one or more radio antennas or transceivers to locate others of the two or more moving aircraft in order to focus and synchronize the laser-link between the two or more moving aircraft, wherein the one or more radio antennas or transceivers are used in parallel with the one or more lasers to help the one or more lasers acquire or reacquire the laser-link between the two or more moving aircraft.

2. The method according to claim 1, wherein the two or more moving aircraft are airborne.

3. The method according to claim 2, wherein the two or more moving aircraft are part of a dynamic mesh of airborne aircraft.

4. The method according to claim 2, wherein the airborne aircraft are in level flight.

5. The method according to claim 1, wherein, when one of the two or more moving aircraft is on ground, system data is received from a local earth station.

6. The method according to claim 5, wherein the system data is received via an omnidirectional radio antenna provided on the one of the two or more moving aircraft.

7. The method according to claim 1, wherein, when one of the two or more moving aircraft is on ground, the one aircraft's laser is directed to a boarding gate or other local terrestrial line-of-sight laser.

8. The method according to claim 1, wherein, when one of the two or more moving aircraft is taxiing or taking-off, the one aircraft receives updated data regarding a dynamic mesh it is to become part of.

9. The method according to claim 1, wherein, when one of the two or more moving aircraft becomes airborne after take-off and circumstances are favorable, the laser-link is established between the one moving aircraft and others of the two or more moving aircraft of a dynamic mesh, wherein the one or more radio antennas or transceivers are used to synchronize the laser-link between the one moving aircraft and the other moving aircraft when circumstances are unfavorable.

10. A system of synchronizing a laser-link between plural moving aircraft, each aircraft comprising:
one or more lasers for establishing the laser-link with other aircraft,
one or more radio antennas or transceivers to locate others of the two or more moving aircraft in order to focus and synchronize the laser-link between the plural moving aircraft, wherein the one or more radio antennas or transceivers are arranged to be used in parallel with the one or more lasers to help the one or more lasers acquire or reacquire the laser-link between the plural moving aircraft.

11. The system according to claim 10, wherein each said aircraft further comprising an omnidirectional radio antenna.

12. The system according to claim 10, wherein each said aircraft further comprising a Global Positioning System (GPS) or Global Navigation and Satellite System (GLONASS) antenna.

13. The system according to claim 10, wherein each said aircraft comprises a cabin with windows, the windows being configured to block laser light from passing through the windows into the cabin.

14. The system according to claim 10, the plural aircraft being part of a dynamic mesh of airborne aircraft.

15. The system according to claim 14, wherein the dynamic mesh comprises 10's, 100's or even 1000's of the airborne aircraft.

16. The system according to claim 14, wherein the dynamic mesh forms an airborne network in communicative contact with one or more earth stations, ships or satellites.

17. The system according to claim 16, wherein the communicative contact is established via the laser-link.

18. The system according to claim 14, wherein, when circumstances are unfavorable for using the laser-link, a radio link is used to establish contact and transfer data.

19. (canceled)

20. A non-transitory computer-readable medium comprising a computer program comprising instructions which, when the computer program is executed by a computer, cause the computer to carry out the method of claim 1.
